(19) United States
(12) Patent Application Publication
(10) Pub. No.: US 2025/0155162 A1
(43) Pub. Date: May 15, 2025

(54) WATER HEATER

(71) Applicant: KYUNGDONG NAVIEN CO., LTD., Gyeonggi-do (KR)

(72) Inventor: In Soo HWANG, Seoul (KR)

(73) Assignee: KYUNGDONG NAVIEN CO., LTD., Gyeonggi-do (KR)

(21) Appl. No.: 18/725,157

(22) PCT Filed: Sep. 20, 2022
(86) PCT No.: PCT/KR2022/014047

§ 371 Date: Jun. 28, 2024

(30) Foreign Application Priority Data
Dec. 30, 2021 (KR) 10-2021-0192758

(51) Int. Cl. F24H 1/28; F24H 9/1832; F28D 21/00

(52) U.S. Cl. CPC F24H 1/287; F24H 9/1832; F28D 21/0007

(57) ABSTRACT

A water heater according to the present invention comprises: a combustion chamber; a burner provided to cause a combustion reaction in the combustion chamber; a plurality of circulation pipes that communicate with the combustion chamber so that combustion gas generated by the combustion reaction flows through the inside; a circulation housing that surrounds the plurality of circulation tubes and the combustion chamber so that circulating water flows to the surroundings of the plurality of circulation tubes and the combustion chamber; a pre-stage heat exchanger that communicates with the plurality of circulation tubes to exchange heat between direct water and combustion gas passing through the plurality of circulation tubes to generate pre-stage hot water; and a main heat exchanger that is connected to the pre-stage heat exchanger and the circulation housing, to generate hot water by exchanging heat between the hot water received from the pre-stage heat exchanger and the hot water delivered from the circulation housing.

### TECHNICAL FIELD

The present disclosure relates to a water heater.

### BACKGROUND ART

A water heating device is a device that heats and discharges water, and includes a boiler and a water heater. The water heater may use various means to heat water. In general, water is heated by causing a combustion reaction from gas or an oil-type fuel and air, and transferring radiant heat and combustion gas generated due to the combustion reaction to the water. Latent heat that is generated when the combustion gas is condensed may be used to heat water.

Water heaters include a water pipe-type water heater that allows combustion gas generated by a combustion reaction to pass through a periphery of a pipe, through which water passes, and a tube-type water heater that allows combustion gas to pass through a pipe and water to pass through a periphery of the pipe.

FIG. 1 is a view of an exemplary water heater. An exemplary water heater is a tube-type water heater with an open-type direct water circuit. A combustion reaction occurs in the combustion chamber 101 to generate combustion gas, which passes through a tube 102), and as direct water flows into an outer cylinder 103 around the tube 102 and flows around the tube, heat exchange occurs and the water may be heated and discharged. When a tube-type water heater, which is a type of a water heater among water heaters, the combustion chamber 101, in which the combustion reaction occurs, may be overheated when a flow rate of hot water used is very low. Water may flow near the high-temperature combustion chamber 101, and lime “L” may be generated by ionic substances contained in the water. Lime “L” may become stuck near the combustion chamber 101, and cracks may occur when heat is concentrated in an area, in which lime “L” is laminated.

To solve this problem, an indirect heating type water heater that generates hot water by causing water around the combustion chamber to continuously flow and exchanging heat with direct water in a new heat exchanger may be used. However, when an indirect heating type water heater is used, a temperature of the returned water is high, and thus, condensation does not occur efficiently in the tube, and the temperature of the discharged combustion gas increases. Accordingly, the development of the water heater that prevents lime and crack formation while allowing sufficient heat exchange between the combustion gas and the water is required.

### TECHNICAL PROBLEM

The present disclosure is designed to solve these problems, and is to provide a water heater that allows sufficient heat exchange from combustion gas to water while preventing lime and cracks.

### TECHNICAL SOLUTION

According to an aspect of the present disclosure, a water heater includes a combustion chamber, a burner that causes a combustion reaction in the combustion chamber, a plurality of combustion tubes communicating with the combustion chamber so that combustion gas generated by the combustion reaction flows through an interior thereof, a circulation housing surrounding the plurality of combustion tubes and the combustion chamber so that circulating water flows to a periphery of the plurality of combustion tubes and the combustion chamber, a pre-stage heat exchanger communicating the plurality of combustion tubes to generate pre-stage hot water by exchanging heat between direct water and the combustion gas having passed through the plurality of combustion tubes, and a main heat exchanger connected to the pre-stage heat exchanger and the circulation housing so that the pre-stage hot water received from the pre-stage heat exchanger generates hot water by exchanging heat with the hot water received from the circulation housing.

### ADVANTAGEOUS EFFECTS

Accordingly, sufficient heat exchange from the combustion gas to the water may occur while preventing lime and cracks.

### DESCRIPTION OF DRAWINGS

FIG. 1 is a view of an exemplary water heater.

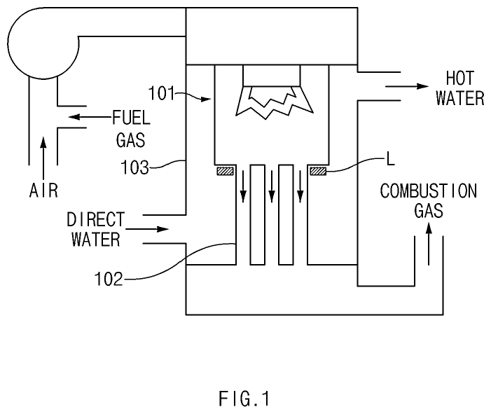

FIG. 2 is a view of a water heater according to a first embodiment of the present disclosure.

FIG. 3 is a view illustrating an area that is adjacent to a pre-stage heat exchanger according to a first embodiment of the present disclosure.

FIG. 4 is a view illustrating an area that is adjacent to a division part according to a second embodiment of the present disclosure.

FIG. 5 is a view illustrating a division part according to a third embodiment of the present disclosure.

FIG. 6 is a view of a water heater according to a fourth embodiment of the present disclosure.

### MODE FOR INVENTION

This application claims the benefit of priority to Korean Patent Application No. 10-2021-0192758, filed in the Korean Intellectual Property Office on Dec. 30, 2021, the entire contents of which are incorporated herein by reference.

Hereinafter, embodiments of the present disclosure will be described in detail with reference to the accompanying drawings. In adding reference numerals to the components of the drawings, it is noted that the same components are denoted by the same reference numerals even when they are drawn in different drawings. Furthermore, in describing the embodiments of the present disclosure, when it is determined that a detailed description of related known configurations and functions may hinder understanding of the embodiments of the present disclosure, a detailed description thereof will be omitted.

Furthermore, in describing the components of the embodiments of the present disclosure, terms, such as first, second, “A”, “B”, (a), and (b) may be used. The terms are simply for distinguishing the components, and the essence, the sequence, and the order of the corresponding components are not limited by the terms. When it is described that a certain component is “connected to”, “coupled to” or “electrically connected to” a second component, it should be understood that the component may be directly connected or electrically connected to the second component, but a third component may be “connected” or “electrically connected” between the components.

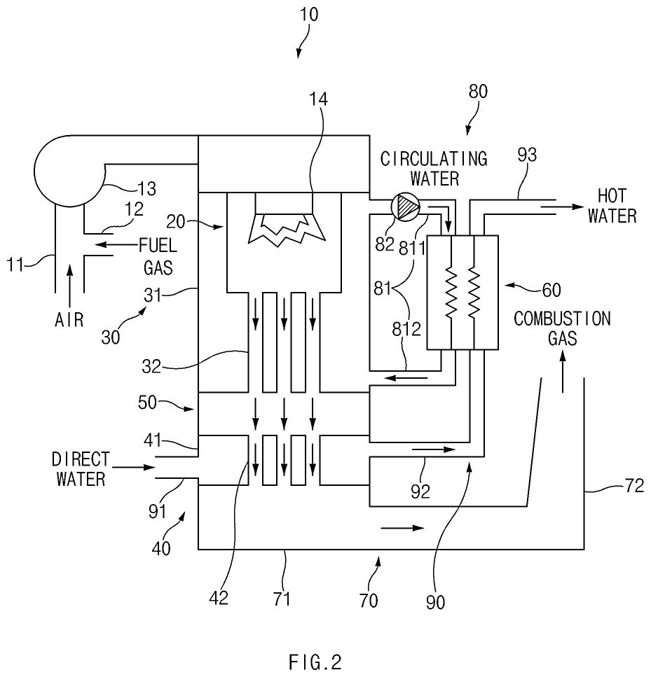

FIG. 2 is a view of a water heater according to a first embodiment of the present disclosure.

Referring to the drawing, the water heater according to the first embodiment of the present disclosure includes a combustion chamber 20, a burner 10, a combustion tube 32, a circulation housing 31, a pre-stage heat exchanger 40, and a main heat exchanger 60.

### Combustion Chamber 20

The combustion chamber 20 is a component that has an inner space, in which a combustion reaction occurs. The combustion chamber 20 may be formed in a cylindrical shape. A burner 10 may be disposed at an upper portion of the combustion chamber 20, and a lower surface of the combustion chamber 20 may be connected to the combustion tube 32 so that the inner space of the combustion chamber 20 communicates with the combustion tube 32.

### Burner 10

The burner 10 causes a combustion reaction in the combustion chamber 20. The burner 10 may be coupled to an upper portion of the combustion chamber 20. The burner 10 may include an air supply pipe 11 for receiving air and a fuel supply pipe 12 for receiving fuel. The fuel may be of a gas type.

The burner 10 may include a blower 13. The air supply pipe 11 and the fuel supply pipe 12 may be connected to each other and lead to the blower 13. The blower 13 is a device that may pump gas, and may receive electric power to pump the gas. The blower 13 may include a driving part that receives electric power and generates a rotational driving force, and an impeller that receives the driving force generated by the driving part to be rotated and pumps the gas. However, a configuration of the blower 13 is not limited thereto.

The burner 10 may include a mixing chamber 14. The blower 13 may receive fuel and air and pumps them to the mixing chamber 14, and thus, the fuel and air may be mixed in the mixing chamber 14 to create a mixture. The mixing chamber 14 may be disposed on an upper side of the combustion chamber 20. The burner 10 may include an igniter. The igniter may ignite the mixture mixed in the mixing chamber 14 by generating a spark. Because the burner 10 is located on an upper side of the combustion chamber 20, the flame generated together with the combustion reaction may be formed downward. The combustion gas generated by the combustion reaction may flow downward from the combustion chamber 20.

### Combustion Tube 32

The water heater according to the first embodiment of the present disclosure may include a circulation part 30, and the circulation part 30 may include a combustion tube 32 and a circulation housing 31. The combustion tube 32 is a component that is formed such that that the combustion gas generated by the combustion reaction flows through an interior thereof. The combustion tube 32 may extend along an upward/downward direction. The combustion tube 32 communicates with the combustion chamber 20 to receive combustion gas. An upper end of the combustion tube 32 may be connected to a lower end of the combustion chamber 20, and a lower end of the combustion tube 32 may be connected to a division part 50 that will be described later, so that the combustion tube 32 may communicate with the combustion chamber 20 and the division part 50.

A cross section of the combustion tube 32, which is taken by a plane that is perpendicular to the upward/downward direction, may be circular, and may have various shapes, such as an elliptical shape or a slot that extends in one direction.

A plurality of combustion tubes 32 may be provided. The plurality of combustion tubes 32 may be disposed to be spaced apart from each other along a direction that is perpendicular to the upward/downward direction. The combustion tubes 32 may be arranged along a circumferential direction of a circle with an arbitrary center point in a plane that is perpendicular to the upward/downward direction, but the arrangement of the combustion tubes 32 is not limited thereto.

The circulating water may flow to a periphery of the combustion tube 32. High-temperature combustion gas flows in an interior of the combustion tube 32, and the circulating water flows to an outside of the combustion tube 32 so that heat transfer occurs from the combustion gas to the circulating water through the combustion tube 32.

### Circulation Housing 31

The circulation housing 31 surrounds the combustion tube 32 and the combustion chamber 20. An upper end of the circulation housing 31 may be coupled to the burner 10. The combustion tube 32 and the combustion chamber 20 may be located in a space that is defined by the burner 10 and the circulation housing 31. Accordingly, the circulating water may flow between an outer surface of the combustion tube 32 and an inner surface of the circulation housing 31, and between an outer surface of the combustion chamber 20 and an inner surface of the circulation housing 31. The circulating water may flow to a periphery of the combustion tube 32 and the combustion chamber 20 by the circulation housing 31. Because the high-temperature combustion gas may flow in an interior of the combustion chamber 20 and an interior of the combustion tube 32, the circulating water that flows on an outside of the combustion chamber 20 and an outside of the combustion tube 32 may receive the heat of combustion gas from the combustion chamber 20 and the combustion tube 32.

The circulation housing 31 may be formed in a cylindrical shape. An upper end of the circulation housing 31 may be closed by the combustion chamber 20 and the burner 10.

### Pre-stage Heat Exchanger 40

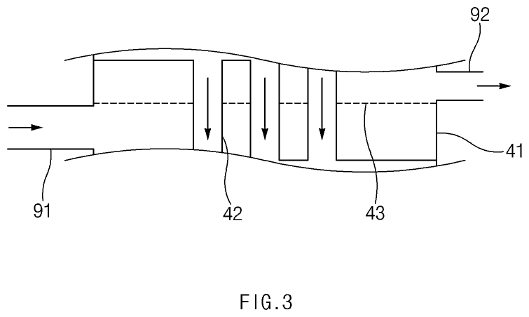

FIG. 3 is a view illustrating an area that is adjacent to the pre-stage heat exchanger 40 according to the first embodiment of the present disclosure.

The pre-stage heat exchanger 40 is a heat exchanger that generates the pre-stage hot water by heating the direct water. The pre-stage heat exchanger 40 generates the pre-stage hot water that is direct water that is heated by exchanging heat between the direct water and the combustion gas that has passed through the combustion tube 32. In the pre-stage heat exchanger 40, latent heat due to condensation of the combustion gas may be transferred to the direct water. Because the direct water is first heated by the pre-stage heat exchanger 40 and then is delivered to the main heat exchanger 60, a high thermal efficiency may be secured.

Accordingly, the pre-stage heat exchanger 40 communicates with the combustion tube 32. The pre-stage heat exchanger 40 may include a pre-stage tube 42 that is formed such that the combustion gas discharged from the combustion tube 32 flows through an interior thereof. The direct water flows to a periphery of the pre-stage tube 42, and may be heated to become pre-stage hot water. In an interior of the pre-stage tube 42, the combustion gas may be condensed to form condensate.

The pre-stage tube 42 may extend along the upward/downward direction. A lower end of the pre-stage tube 42 may communicate with an exhaust part 70 that will be described later. A cross section of the pre-stage tube 42, which is taken by a plane that is perpendicular to the upward/downward direction, may be circular, and may have various shapes, such as an elliptical shape or a slot that extends in one direction. The condensate generated in the pre-stage tube 42 may fall downward and be discharged into a condensate receiver 71.

A plurality of pre-stage tubes 42 may be provided. The number of pre-stage tubes 42 may be the same as the number of combustion tubes 32. The plurality of pre-stage tubes 42 may be disposed to be spaced apart from each other along a direction that is perpendicular to the upward/downward direction. The pre-stage tubes 42 may be disposed along a circumferential direction of a circle with an arbitrary center point in a plane that is perpendicular to the upward/downward direction, but the arrangement of the pre-stage tubes 42 is not limited thereto.

The pre-stage heat exchanger 40 includes a pre-stage housing 41. The pre-stage housing 41 may surround the pre-stage tube 42 so that the direct water flows to a periphery of the pre-stage tube 42. The combustion gas that passes through the pre-stage tube 42 and the direct water that passes through a periphery of the pre-stage tube 42 exchange heat with each other to generate the pre-stage hot water.

The water heater according to the first embodiment of the present disclosure may include a hot water path 90. The hot water path 90 may include a direct water pipe 91. The direct water pipe 91 may be connected to the pre-stage housing 41, and may communicate with an interior and an exterior of the pre-stage housing 41. The direct water pipe 91 may be connected to the water source, and may receive the direct water from a water source and cause it to be introduced into the inner space of the pre-stage housing 41. In the inner space of the pre-stage housing 41, the direct water may flow along a periphery of the pre-stage tube 42 to exchange heat.

The hot water path 90 may include a pre-stage pipe 92. The pre-stage pipe 92 may connect the pre-stage housing 41 and the main heat exchanger 60. Accordingly, the pre-stage hot water formed in the pre-stage heat exchanger 40 may be delivered to the main heat exchanger 60 through the pre-stage pipe 92.

The pre-stage heat exchanger 40 may include a partition 43. The partition 43 is a plate-shaped component, through which the pre-stage tube 42 passes in an interior of the pre-stage housing 41. A tube hole may be formed in the partition 43 so that the pre-stage tube 42 passes therethrough. Among the tube holes, there may be a wide tube hole, through which adjacent pre-stage tubes 42 may pass together. In addition to the tube hole, a through-hole may be formed in the partition 43 so that the direct water passes therethrough although the pre-stage tube 42 does not pass through it. By disposing the partition 43, flow path of a direct water may be arbitrarily formed in the pre-stage heat exchanger 40.

### Main Heat Exchanger 60

The main heat exchanger 60 is a component that receives the pre-stage hot water and exchanges heat with the circulating water to generate the hot water. The main heat exchanger 60 may be connected to the pre-stage heat exchanger 40 and the circulation housing 31 so that the hot water is generated by exchanging heat between the pre-stage hot water received from the pre-stage heat exchanger 40 and the hot water received from the circulation housing 31.

That is, the main heat exchanger 60 is a component that, when the direct water is primarily heated in the pre-stage heat exchanger 40 to become pre-stage hot water, secondarily heats the pre-stage hot water to form final hot water. With the hot water heating structure and the circulating water circulation structure, a problem of formation of a lime due to overheating may be reduced, and heat exchange with the direct water occurs sufficiently when hot water is formed so that high temperature hot water may be obtained.

The main heat exchanger 60 may be a plate type heat exchanger, in which a plurality of plates are stacked and heat exchange occurs by causing different fluids to flow through passages that do not communicate with each other, which are formed between each plate. However, the main heat exchanger may be a shell-and-tube heat exchanger, in which a water pipe is located in an interior of a barrel to cause a heat exchange between fluids that flow along an inside and an outside of the water pipe, and may be a tube-and-tube heat exchanger that is configured to cause a heat exchange between the fluids that flow along an inside of an inner pipe of a dual pipe and an outside of the inner pipe.

The water heater according to the first embodiment of the present disclosure may include a circulation operating part 80. The circulation operating part 80 may include a circulation pipe 81. The circulation pipe 81 is a pipe that connects the main heat exchanger 60 and the circulation housing 31 so that the circulating water circulates between the circulation housing 31 and the main heat exchanger 60. The circulation pipe 81 may include a discharge pipe 811 that receives the circulating water from the circulation housing 31 and delivers it to the main heat exchanger 60, and a water recovery pipe 812 that returns the circulating water cooled through heat exchange in the main heat exchanger 60 to the circulation housing 31. The circulation operating part 80 may be disposed such that a closed circuit, through which circulating water flows, may be formed. Because the closed circuit is formed, generation of limes may be reduced in the water heater according to an embodiment of the present disclosure, and continuous circulation of the circulating water occurs along the closed circuit so that overheating of the circulating water around the combustion chamber 20 may be prevented.

The circulation operating part 80 may include a pump 82. The pump 82 is a device that pumps the circulating water so that the circulating water may circulate through the circulation pipe 81. The pump 82 may receive electric power to be operated. The pump 82 may be disposed in the discharge pipe 811, and may be disposed in the water recovery pipe 812.

The hot water path 90 may include a hot water pipe 93. The hot water pipe 93 is a pipe that receives the hot water generated in and discharged from the main heat exchanger 60 and discharges it to a source of demand.

### Division Part 50

The water heater according to the first embodiment of the present disclosure may include the division part 50. The division part 50 is a component that divides an interior of the circulation housing 31 and an interior of the pre-stage heat exchanger 40 so that the water that flows in the circulation housing 31 and the water that flows in the pre-stage heat exchanger 40 are not be mixed. The division part 50 may be coupled to the pre-stage heat exchanger 40 and the combustion tube 32. The division part 50 may deliver the combustion gas received from the combustion tube 32 to the pre-stage heat exchanger 40. The components may be disposed from a top to a bottom in the order of the combustion tube 32, the division part 50, and the pre-stage heat exchanger 40. The division part 50 may be formed in a cylindrical shape. The circulation housing 31, the pre-stage housing 41, and the division part 50 may be formed in a cylindrical shape with the same diameter so that they may form a continuous appearance.

### Exhaust Part 70

The water heater according to the first embodiment of the present disclosure may include the exhaust part 70. The exhaust part 70 is a component for processing the by-products of combustion. The exhaust part 70 may be disposed on a lower side of the pre-stage heat exchanger 40.

The exhaust part 70 may include the condensate receiver 71. The condensate receiver 71 may be located on a lower side of the pre-stage heat exchanger 40, and may receive and collect the condensate that is generated and falls from the pre-stage tube 42. The condensate receiver 71 may be connected to a drain pipe for discharging the condensate, and a water trap that prevents the combustion gas from leaking may be disposed on the drain pipe. The water trap includes a neutralizing section, and may neutralize the discharged condensate.

The exhaust part 70 may include an exhaust duct 72. The exhaust duct 72 may lead from the condensate receiver 71, and may discharge the combustion gas delivered through the pre-stage tube 42 to an outside.

### Second Embodiment

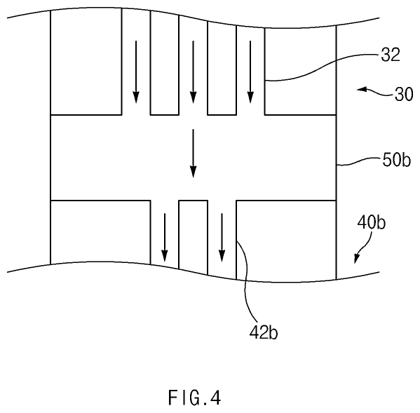

FIG. 4 is a view illustrating an area that is adjacent a division part 50b according to a second embodiment of the present disclosure.

The water heater according to the second embodiment of the present disclosure differs from the water heater according to the first embodiment only in the configurations of the division part 50b and the pre-stage heat exchanger 40b, and thus, only the different parts will be further described, and a description of the water heater according to the first embodiment may be applied to the remaining components.

The number of the combustion tubes 32 according to the second embodiment of the present disclosure is different from the number of the pre-stage tubes 42b. For example, as illustrated, there may be three combustion tubes 32 and two pre-stage tubes 42b. Accordingly, a shape of the division part 50b connected to the combustion tube 32 and the pre-stage tube 42b may also be different from that in the first embodiment.

However, on the contrary, the number of the pre-stage tubes may be greater than the number of the combustion tubes. The cross-sectional area of the combustion tubes and the cross-sectional area of the pre-stage tube may be the same or different, and the cross-sectional shape may be the same or different.

### Third Embodiment

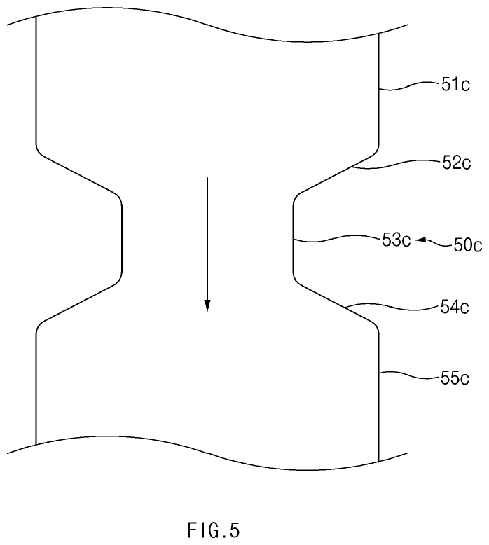

FIG. 5 is a view illustrating a division part 50c according to a third embodiment of the present disclosure.

The water heater according to the third embodiment of the present disclosure differs from the water heater according to the first embodiment only in the shape of the division part 50c, and thus only the different parts may be further described, and the description of the water heater according to the first embodiment may be applied to the remaining parts.

The division part 50c according to the third embodiment of the present disclosure may have a shape, of which a cross-sectional area taken by a plane that is perpendicular to the direction, in which combustion gas flows, decreases and then increases along the direction, in which combustion gas flows.

In detail, the division part 50c according to the third embodiment may include a first section 51c, a cross-sectional area of which is maintained as it gores downward, a second section 52c that extends downward from a lower end of the first section 51c and has a cross-sectional area that decreases downward, a third section 53c that extends downward from a lower end of the second section 52c and maintains a cross-sectional area, a fourth section 54c that extends downward from a lower end of the third section 53c and has a cross-sectional area that increases downward, and a fifth section 55c that extends downward from a lower end of the fourth section 54c and maintains a cross-sectional area. The division part 50c may have a shape that is symmetrical with respect to the plane when the third section is cut by a plane that is perpendicular to the upward/downward direction.

### Fourth Embodiment

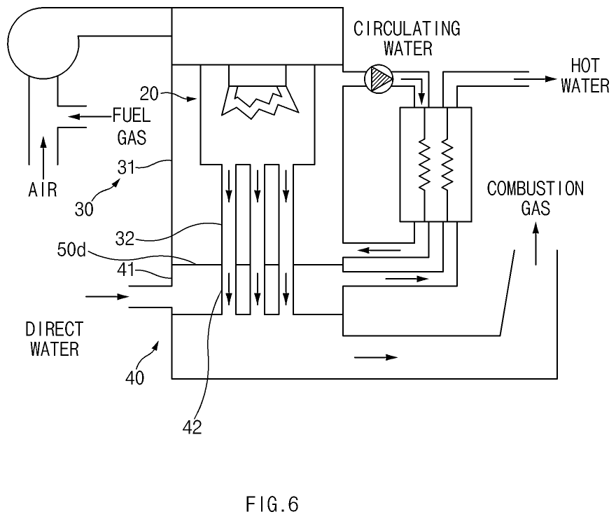

FIG. 6 is a view of a water heater according to a fourth embodiment of the present disclosure.

The water heater according to the fourth embodiment of the present disclosure differs from the water heater according to the first embodiment only in the shape of a division part 50d, and thus only the different parts will be further described, and the description of the water heater according to the first embodiment may be applied to the remaining parts.

The division part 50d according to the fourth embodiment of the present disclosure may be formed in a plate shape that is be inserted into the combustion tube 32 and the pre-stage tube 42, similar to the partition 43 of FIG. 4. However, unlike the partition 43, the division part 50d may be blocked so that the fluid cannot pass therethrough. The division part 50d does not have an inner space, but simply divides the interior of the circulation housing 31 and the interior of the pre-stage housing 41 to distinguish the circulation part 30 from the pre-stage heat exchanger 40.

That is, the circulation housing 31 and the pre-stage housing 41 may be disposed while the division part 50d is disposed in the interior of the integral housing, and the division part 50d may be coupled to an inner surface of the housing without any gaps to maintain watertightness so that the integral housing may be formed to be divided. Then, welding may be used to couple the division part 50d to the housing inner surface. An upper portion of the integral housing, which is divided by the division part 50d, may be the circulation housing 31, and a lower portion thereof may be the pre-stage housing 41. Also similarly for the tubes, the combustion tube 32 and the pre-stage tube 42 may be formed by inserting them without any gaps to maintain watertightness so that the integral tubes may be formed to be divided. Then, welding may be used to couple the division part 50d to the tube. The upper portion of the integral tube, which is divided by the division part 50d, may be the combustion tube 32, and a lower portion thereof may be the pre-stage tube 42.

No gap is formed between the division part 50d and the tube, or between the division part 50d and the inner surface of the housing, so that the inside of the circulation housing 31 and the inside of the pre-stage housing 41 may be completely separated from each other whereby so that fluids cannot enter or exit. When the division part 50d is welded to couple the tube and the housing, a laser may be used.

In the above description, just because all the components constituting the embodiment of the present disclosure are described as being combined or operating in combination, the present disclosure is not necessarily limited to this embodiment. That is, within the scope of the purpose of the present disclosure, all of the components may operate in selective combination of one or more. In addition, terms such as “include,” “comprise,” or “have” described above mean that the corresponding component may be present, and thus do not exclude other components unless specifically stated to the contrary, and rather, it should be interpreted as being able to include other components. Unless defined differently, all the terms including technical or scientific terms have the same meanings as those generally understood by an ordinary person in the art, to which the present disclosure pertains. The terms, such as the terms defined in dictionaries, which are generally used, should be construed to coincide with the context meanings of the related technologies, and are not construed as ideal or excessively formal meanings unless explicitly defined in the present disclosure.

The above description is a simple exemplary description of the technical spirits of the present disclosure, and an ordinary person in the art, to which the present disclosure pertains, may make various corrections and modifications without departing from the essential characteristics of the present disclosure. Therefore, the embodiments disclosed in the present disclosure are not for limiting the technical spirits of the present disclosure but for describing them, and the scope of the technical spirits of the present disclosure is not limited by the embodiments. The protection scope of the present disclosure should be construed by the following claims, and all the technical spirits in the equivalent range should be construed as being included in the scope of the present disclosure.

1. A water heater comprising:
a combustion chamber;
a burner configured to cause a combustion reaction in the combustion chamber;
a plurality of combustion tubes communicating with the combustion chamber so that combustion gas generated by the combustion reaction flows through an interior thereof;
a circulation housing surrounding the plurality of combustion tubes and the combustion chamber so that circulating water flows to a periphery of the plurality of combustion tubes and the combustion chamber;
a pre-stage heat exchanger communicating the plurality of combustion tubes to generate pre-stage hot water by exchanging heat between direct water and the combustion gas having passed through the plurality of combustion tubes; and
a main heat exchanger connected to the pre-stage heat exchanger and the circulation housing so that the pre-stage hot water received from the pre-stage heat exchanger generates hot water by exchanging heat with the hot water received from the circulation housing.

2. The water heater of claim 1, further comprising:
a division part configured to divide an interior of the circulation housing and an interior of the pre-stage heat exchanger.

3. The water heater of claim 2, wherein the division part is coupled to the pre-stage heat exchanger and the combustion tubes so that the combustion gas received from the plurality of combustion tubes is delivered to the pre-stage heat exchanger.

4. The water heater of claim 3, wherein the division part has a shape, of which a cross-section is taken by a plane being perpendicular to a direction, in which the combustion gas flows, decreases and then increases as it goes along the direction, the combustion gas flows.

5. The water heater of claim 1, wherein the pre-stage heat exchanger includes:
a plurality of pre-stage tubes configured such that the combustion gas discharged from the plurality of combustion tubes flows through an interior thereof; and
a pre-stage housing surrounding the pre-stage tubes so that the direct water flows to a periphery of the pre-stage tubes.

6. The water heater of claim 5, wherein the number of the plurality of combustion tubes and the plurality of pre-stage tubes are different.

7. The water heater of claim 5, wherein the pre-stage heat exchanger further includes a plate-shape partition, through which the plurality of pre-stage tubes pass in an interior of the pre-stage housing.

8. The water heater of claim 7, wherein the partition has a through-hole so that the direct water passes therethrough.

9. The water heater of claim 1, further comprising:
a circulation pipe connecting the main heat exchanger and the circulation housing so that the circulating water circulates in the circulation housing and the main heat exchanger.

10. The water heater of claim 1, wherein the main heat exchanger is any one of a plate type heat exchanger, a shell-and-tube heat exchanger, and a tube-and-tube heat exchanger.
